(19) United States
(12) Patent Application Publication
(10) Pub. No.: US 2026/0192801 A1
(43) Pub. Date: Jul. 9, 2026

(54) Method and Device for Controlling an Automated Motor Vehicle

(71) Applicant: Bayerische Motoren Werke Aktiengesellschaft, Muenchen (DE)

(72) Inventors: Jakob HUEMER, Muenchen (DE); Walter KAGERER, Muenchen (DE); Andreas SPAETH, Lindau (DE)

(21) Appl. No.: 18/868,606

(22) PCT Filed: May 3, 2023
(86) PCT No.: PCT/EP2023/061597

§ 371 Date: Nov. 22, 2024

(30) Foreign Application Priority Data
Jun. 1, 2022 (DE) 10 2022 113 810.0

(51) Int. Cl. B60W 30/18; B60K 35/81

(52) U.S. Cl. CPC B60W 30/18009; B60K 35/81; B60W 2554/801; B60W 2710/30

(57) ABSTRACT

A method for controlling an automated motor vehicle includes detecting a predefined driving situation in which a system to be operated by a driver of the automated motor vehicle is laterally next to a roadway in an environment of the vehicle. If the predefined driving situation is detected, the motor vehicle is automatically maneuvered into a destination position in which a window of the motor vehicle next to a driver's seat of the motor vehicle and the system are at the same height and a lateral distance between the window and the system is below a predefined limit value. A pane of the window is moved down before and/or when the destination position is reached.

### BACKGROUND AND SUMMARY

The present disclosure relates to a method for controlling an automated motor vehicle, and to a data processing device configured to at least partially execute the method. Further, an automated motor vehicle with the data processing device is provided. Additionally, or alternatively, there is provided a computer program comprising instructions which, when the program is executed by a computer, cause the computer to at least partially execute the method. Additionally, or alternatively, there is provided a computer-readable medium comprising instructions which, when the instructions are executed by a computer, cause the computer to at least partially execute the method.

Active and passive maneuvering aids can be made available to the driver of a motor vehicle to assist with maneuvering. Such systems include parking assistants for parking and maneuvering, which assist the driver universally or offer maneuvering assistance in certain maneuvering situations. Passive assistance during maneuvering means that the maneuver assistant issues steering angle specifications to the driver for lateral maneuvering and/or start and stop commands for slow maneuvering. However, the maneuver assistant can also actively perform a maneuver in whole or in part, wherein in the case of fully automatic guidance, the assistance system automatically or autonomously controls the vehicle's braking and drive system in addition to a steering angle adjustment device.

DE 10 2014 206 901 A1 relates to a method for assisting a driver of a vehicle in maneuvering situations, wherein the vehicle has an environment sensor system for determining environment data for situation recognition, comprising recognizing a situation and a position of the vehicle, according to which the driver is offered assistance in maneuvering, creating probabilistic maneuver options based on the situation, creating a priority list of the probabilistic maneuver options based on the probability, outputting the priority list to the driver of the vehicle, selecting a maneuver option by the driver of the vehicle, and enabling the driver to activate the maneuver assistance.

Against the background of this prior art, the object of the present invention is to provide a device and a method which are each suitable for at least enriching the above-mentioned prior art.

The object is achieved by the features of the independent claim. The dependent claims relate to preferred developments of the invention.

The object is then achieved by a method for controlling an automated motor vehicle.

The method may be a computer-implemented method, i.e., one, several or all steps of the method may be performed by a data processing device or a computer.

The method comprises detecting a predetermined driving situation in which a system to be operated by a driver of the automated motor vehicle is located laterally of a roadway in an environment of the motor vehicle The system to be operated can also be referred to as a system to be operated by the driver of the motor vehicle. Operation can comprise user input, e.g., voice input and/or haptic input, into and/or removal of an object, e.g., a ticket, from the system.

The predetermined driving situation can be detected by means of an on-board sensor system of the motor vehicle and/or a sensor system external to the motor vehicle. The detection of the predetermined driving situation can include recognition of the system by means of an object recognition algorithm that recognizes the system based on sensor data recorded by the on-board sensor system. It is also conceivable that a position of the recognized system, in particular relative to the motor vehicle, is determined based on sensor data recorded by the on-board sensor system. The on-board sensor system can include a camera, an ultrasonic sensor, a radar sensor and/or a LiDAR sensor. Additionally, or alternatively, map data can be used to record the predetermined driving situation, in which the presence of the system and possibly its position are optionally stored. It is also conceivable that, additionally or alternatively, V2X (vehicle-to-X) communication is used to obtain information on the predetermined driving situation, in which the presence of the system and possibly its position are optionally present.

More specifically, the detection of the predetermined driving situation or the situation detection can be based, for example, on environment detection by means of environment sensors, comprising ultrasonic, laser, radar, infrared sensors, capacitive sensors, LIDAR sensors and/or video image detection. In particular, situation recognition can be based on the detection of objects outside the vehicle, wherein indicators that point to a specific situation (e.g., road signs) can be relevant. These can be, for example, optical markings, objects and/or (road) boundaries. In addition, or as an alternative, other localization technologies can be used to improve the accuracy of situation recognition. For example, geodata can be determined using a global positioning system, such as dGPS (differential GPS), and/or a digital map with landmarks in combination with odometry.

It is conceivable that in the predetermined driving situation, the width of the roadway on which the vehicle is located falls below a predetermined limit value.

The method further comprises automatedly maneuvering the motor vehicle into a target position in which a window of the motor vehicle next to a driver's seat of the motor vehicle and the system, in particular an input device of the system, optionally comprising a display device and/or a loudspeaker, are at a height, and a lateral distance between the window and the system is below a predetermined limit value when the predetermined driving situation is detected.

That is to say, the lateral distance between the motor vehicle, in particular between the driver of the motor vehicle, and the system should be below a certain threshold value, e.g., 80 cm. Preferably, the distance is less than the length of the driver's arm. The distance can be less than 75 cm, 73 cm, 70 cm, 65 cm, 60 cm, 55 cm, 50 cm, 45 cm, 40 cm, 30 cm, 25 cm or 20 cm. The distance can, additionally or alternatively, be adjustable by the driver via a configuration option in the vehicle. The distance can be measured substantially orthogonally to a user input interface of the system and this user input interface and a lateral outer surface of the motor vehicle, e.g., the window of the motor vehicle, which is located laterally of the driver's seat of the motor vehicle.

It is conceivable that the automated maneuvering of the motor vehicle could include an automated takeover of a transverse and/or longitudinal guidance of the motor vehicle. The motor vehicle's on-board sensor system and/or the motor vehicle's external sensor system can be used for this purpose.

This means that, depending on the degree of automation of the motor vehicle (described in detail further below), the motor vehicle can take over control of steering, braking, speed and/or acceleration of the motor vehicle and can drive the motor vehicle to the system in a fully or partially automated manner.

In other words, the driver can be offered passive or active assistance during maneuvering. As described at the outset, passive assistance during maneuvering can mean that the maneuver assistant issues steering angle specifications to the driver for lateral guidance and/or start and stop commands for longitudinal guidance. However, the maneuver assistant can also fully or partially carry out a maneuver actively, wherein, in the case of fully automatic guidance, in addition to a steering angle adjustment device, the braking and drive system of the vehicle can also be actuated automatically or autonomously by the assistance system.

The method also includes an (automated) lowering of a pane of the window before and/or when the target position is reached.

This enables the driver to enter user data into the system without having to operate the window manually.

The driver is assisted from his motor vehicle by the method when moving off and positioning the motor vehicle precisely, especially in confined situations such as drive-through counters (e.g., toll station, drive-through bank, etc.). The method positions the motor vehicle in the correct place and brings it to a standstill, wherein this position is as close as possible or necessary to the system, e.g., a counter or order window of a drive-through restaurant. This minimizes the risk of a collision between the surrounding buildings and the exterior or side mirror or the side of the vehicle.

Possible further developments of the method are described in detail below.

The method can comprise folding in an exterior mirror of the motor vehicle, which is arranged on a side of the motor vehicle on which the window is arranged, before and/or when the target position is reached. This means that the side mirror or exterior mirror on the driver's side can be folded in or folded inwards. Additionally, or alternatively, the side mirror on the front passenger's side can also be folded inwards, so that the following description applies to the side mirrors on both the driver's and front passenger's side.

The exterior mirror can be folded in exclusively or only if failure to fold it in would lead to a collision between the exterior mirror and the system. In addition, or alternatively, folding in can take place, in particular exclusively, if a collision of the exterior mirror with a surrounding structure would occur without folding in.

The method can include folding out the exterior mirror after reaching the target position if a first predetermined condition is fulfilled.

The method may include raising the pane of the window after reaching the target position if a second predetermined condition is met.

It is conceivable that the second predetermined condition is fulfilled when the driver has completed the user input and/or continues the journey.

The method may include automated maneuvering of the motor vehicle from the target position away from the system if a third predetermined condition is met.

The first, the second and/or the third predetermined condition may be the same or a different condition. It is conceivable that the first predetermined condition is fulfilled when the distance between the motor vehicle and the system or the surrounding buildings is so great that a collision of the exterior mirror with the system or the surrounding buildings is no longer possible. It is conceivable that the second and/or the third predetermined condition is fulfilled when the driver has completed the user input. It is conceivable, additionally or alternatively, that the third predetermined condition is fulfilled when a barrier in front of the vehicle releases a lane (e.g., barrier 6 opens). It is conceivable that the first condition is assumed to be fulfilled when the motor vehicle has left the target position and is substantially in the middle of the lane. To determine whether the first, the second and/or the third condition is fulfilled, the on-board sensor system of the motor vehicle and/or the external sensor system of the motor vehicle can be used.

The method may comprise generating and outputting a visualization of a position of the motor vehicle relative to the system by means of a display arranged in the motor vehicle.

The method described above can be summarized in other words and in relation to a more specific implementation as described below as not limiting the disclosure: The (motor) vehicle can use off-and/or on-board information to recognize that a corresponding situation exists and can take over positioning of the vehicle at this moment. The vehicle may have already been driven automatically and/or controlled by the driver beforehand. The vehicle can be positioned longitudinally in such a way that the driver can (conveniently) perform the corresponding action (e.g., paying, accepting food or other products, etc.) from the driver's window and without colliding with any barriers or other obstacles that may be present. In addition, the transverse position can be adjusted so that the driver does not have to unbuckle his seatbelt in order to carry out the corresponding activity out of the window. A collision with objects on the side is avoided. If necessary, the exterior mirror can be folded in automatically. When the target position is reached, the window can be opened automatically. When the situation ends, the window can be raised again automatically and, if necessary, the exterior mirror can be folded out again. The system can steer the vehicle back to the center of the road and hand over control to the driver or an appropriate driver assistance system if necessary. During the, optionally entire, course of the procedure, the driver can be shown a (suitable) visualization of the scene via HMI (Human Machine Interface) in an augmented reality view and/or a bird's eye view and/or in the form of an abstract representation. The method can be used at toll booths, for example. The vehicle can recognize the “toll booth” situation, control the vehicle position including any necessary folding in of the exterior mirror, and automatically lower the driver's window. This allows the driver to pay conveniently. The vehicle can then be returned to the center of the lane and the driver can continue driving, or the lane center guidance including slow guidance can be reactivated directly.

Furthermore, a data processing device, e.g., a control unit, is provided for an automated motor vehicle, wherein the control unit is set up to at least partially execute or carry out the method described above. The data processing device can be part of a driver assistance system or can represent such a system. The data processing device may, for example, be an electronic control unit (ECU). The electronic control unit can be an intelligent processor-controlled unit that can communicate with other modules via a central gateway (CGW), for example, and that can form the vehicle electrical system via field buses such as the CAN bus, LIN bus, MOST bus and FlexRay or via automotive Ethernet, e.g., together with telematics control units. It is conceivable that the control unit controls one or more functions relevant to the driving behavior of the vehicle, such as engine control, power transmission, the braking system and/or the tire pressure control system. In addition, driver assistance systems, such as a parking assistant, adaptive cruise control (ACC), a lane departure warning system, a lane change assistant, traffic sign recognition, light signal recognition, a collision assistant, a night vision assistant and/or an intersection assistant, can be controlled by the control unit.

It will be understood that descriptions herein of the method apply analogously to the data processing device, and vice versa.

Furthermore, a motor vehicle comprising the data processing device described above is provided.

The motor vehicle may be a passenger car, in particular an automobile. The motor vehicle can be designed to at least partially and/or at least temporarily take over longitudinal and/or lateral guidance during automated driving of the motor vehicle. Automated driving can take place in such a way that the motor vehicle moves (largely) autonomously. The automated driving can be at least partially and/or temporarily controlled by the data processing device.

The motor vehicle can be an autonomous level 0 vehicle, i.e., the driver takes over the dynamic driving task, even if supporting systems (e.g., ABS or ESP) are present.

The motor vehicle can be an autonomous level 1 vehicle, i.e., can have certain driver assistance systems that support the driver in operating the vehicle, such as adaptive cruise control (ACC).

The motor vehicle can be an autonomous level 2 vehicle, i.e., partially automated in such a way that functions such as automatic parking, lane keeping or lateral guidance, general longitudinal guidance, acceleration and/or braking are taken over by driver assistance systems.

The motor vehicle can be an autonomous level 3 vehicle, i.e., conditionally automated in such a way that the driver does not have to continuously monitor the vehicle system. The vehicle independently performs functions such as triggering the turn signal, changing lanes and/or lane keeping. The driver can turn his attention to other things, but is prompted by the system to take over within a warning time if necessary.

The motor vehicle can be an autonomous level 4 vehicle, i.e., so highly automated that the vehicle is permanently driven by the vehicle system. If the driving tasks are no longer managed by the system, the driver can be requested to take over the driving.

The motor vehicle can be an autonomous level 5 vehicle, i.e., so fully automated that the driver is not required to perform the driving task. Apart from setting the destination and starting the system, no human intervention is required. The vehicle can do without a steering wheel and pedals.

The above with reference to the method and the data processing device also applies analogously to the motor vehicle and vice versa.

Further provided is a computer program comprising instructions which, when the program is executed by a computer, cause the computer to at least partially execute or carry out the method described above.

A program code of the computer program can be present in any code, in particular in a code suitable for motor vehicle control systems.

What is described above with reference to the method, the data processing device and the motor vehicle also applies analogously to the computer program and vice versa.

Furthermore, a computer-readable medium, in particular a computer-readable storage medium, is provided. The computer-readable medium comprises instructions which, when the program is executed by a computer, cause the computer to execute at least part of the method described above.

This means that a computer-readable medium comprising a computer program as defined above can be provided. The computer-readable medium can be any digital data storage device, such as a USB stick, a hard disk, a CD-ROM, an SD card or an SSD card. The computer program does not necessarily have to be stored on such a computer-readable storage medium in order to be made available to the motor vehicle, but can also be obtained via the Internet or otherwise externally.

It will be understood that descriptions herein of the method, the data processing device, the computer program and the automated motor vehicle apply analogously for the computer-readable medium, and vice versa.

At least one embodiment is described herein with reference to FIGS. 1 and 2.

### BRIEF DESCRIPTION OF THE DRAWINGS

FIG. 1 schematically shows a driving situation in which a system to be operated by a driver of the automated motor vehicle is located laterally of a roadway in an environment of the motor vehicle, and

FIG. 2 schematically shows a flow chart of a method for controlling an automated motor vehicle.

### DETAILED DESCRIPTION OF THE DRAWINGS

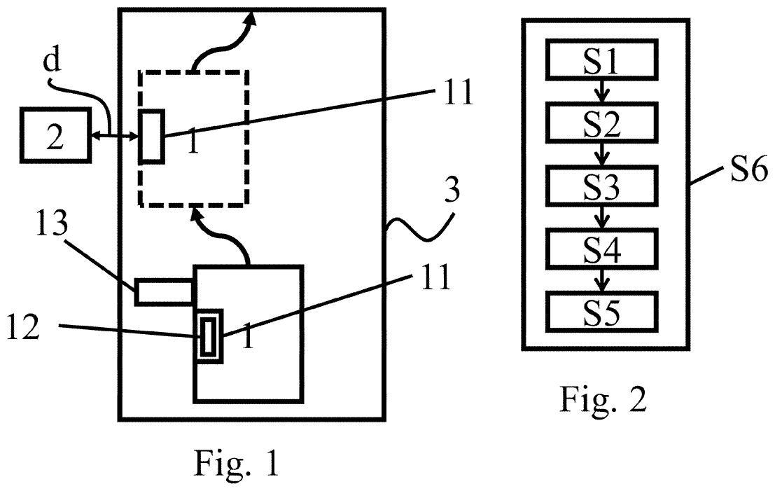

In FIG. 1, a driving situation is shown schematically from a bird's eye view, in which a motor vehicle 1, shown with a solid line, is located on a roadway 3, wherein a system 2 to be operated by a driver of the automated motor vehicle 1 is located laterally of the motor vehicle 1 next to the roadway 3 in environment of the motor vehicle 1, i.e., in this case at a distance from the motor vehicle 1 that is less than a predetermined threshold value. The motor vehicle 1 carries out the method for controlling the automated motor vehicle 1, the flow chart of which is shown in FIG. 2.

In a first step S1 of the method, the driving situation described above is detected by means of the motor vehicle's own sensors and/or sensors external to the motor vehicle. It is detected that this is a predetermined driving situation in which a system 2 to be operated by a driver of the automated motor vehicle 1 is located laterally of a roadway 3 in an environment of the motor vehicle 1.

In a second step S2 of the method, if or as soon as the predetermined driving situation is detected in the first step S1, the motor vehicle 1 is automatically maneuvered to a target position (shown with a dashed line in FIG. 1). In the target position, a window 11 of the motor vehicle 1 next to a driver's seat (not shown) of the motor vehicle 1 and the system 2 are at a height, and a lateral distance d between the window 11 and the system 2 is below a predetermined limit value.

In a third step S3 of the method, which can take place at least partially simultaneously with the second step S2 or after the second step S2, i.e., before and/or when the target position is reached, a pane 12 of the window 11 is lowered, i.e., the window 11 is opened. Likewise, in the third step S3, it is determined that an exterior mirror 13 of the motor vehicle 1 would collide with the system 2 in the target position, so that the mirror is automatically folded in before the target position is reached.

In a fourth step S4 of the method, it is determined that the driver of the motor vehicle 1 wishes to leave the target position (e.g., by a user input via an HMI of the motor vehicle 1).

This fulfills a predetermined condition that, in a fifth step S5 of the method, the target position is left, i.e., the motor vehicle 1 is automatically maneuvered out of the target position away from the system 2. The exterior mirror 13 is also folded out and the pane 12 of the window 11 is automatically raised after reaching the target position if a second predetermined condition is fulfilled.

The method further comprises a sixth step S6, which runs simultaneously with the steps S1-S5 described above and in which a visualization of a position of the motor vehicle 1 relative to the system 2 is generated and output by means of a display (not shown) arranged in the motor vehicle 1.

### LIST OF REFERENCE SIGNS

1 motor vehicle
11 window
12 pane
13 exterior mirror
2 system, e.g., switch
3 roadway
S1-S6 method steps

1-10. (canceled)

11. A method for controlling an automated motor vehicle, comprising:
detecting a predetermined driving situation in which a system to be operated by a driver of the automated motor vehicle is located laterally of a roadway in an environment of the motor vehicle;
in response to detecting the predetermined driving situation, automatically maneuvering the motor vehicle into a target position in which a window of the motor vehicle next to a driver's seat of the motor vehicle and the system are at a height, and in which a lateral distance between the window and the system is below a predetermined limit value; and
lowering a pane of the window before and/or when the target position is reached.

12. The method of claim 11, further comprising:
before and/or upon reaching the target position, folding in an exterior mirror arranged on a same side of the motor vehicle as the window.

13. The method of claim 12, wherein the exterior mirror is folded in exclusively if failure to fold it in would lead to a collision of the exterior mirror with the system.

14. The method of claim 12, wherein, if a first predetermined condition is fulfilled, the exterior mirror is folded in after reaching the target position.

15. The method of claim 11, further comprising:
if a second predetermined condition is fulfilled, raising the pane of the window after reaching the target position.

16. The method of claim 11, further comprising:
if a third predetermined condition is met, automatedly maneuvering the motor vehicle from the target position away from the system.

17. The method of claim 11, further comprising:
generating and outputting a visualization of a position of the motor vehicle relative to the system by means of a display arranged in the motor vehicle.

18. A data processing device for an automated motor vehicle, wherein the data processing device is configured to carry out the method of claim 11.

19. An automated motor vehicle comprising the data processing device of claim 18.

20. A non-transitory computer-readable medium storing processor executable instructions that, when executed by a computer, cause the computer to carry out the method of claim 11.
